(19) United States
(12) Patent Application Publication
(10) Pub. No.: US 2003/0163394 A1
(43) Pub. Date: Aug. 28, 2003

(54) System and method for inventory management

(76) Inventor: Leslie Munn, Superior, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/074,368

(22) Filed: Feb. 12, 2002

(51) Int. Cl. G06F 17/60

(52) U.S. Cl. 705/28

(57) ABSTRACT

A system and method for inventory management is described. A method for managing an inventory, the method comprising. In one embodiment, the method includes the steps of establishing an account for a customer; receiving product information, the product information corresponding to a non-fungible product selected by the customer; verifying that the account balance is equal to or greater than a cost associated with the selected product; adjusting the account balance by the cost associated with the selected product; determining a location for the selected product; and transferring the unique product identifier and the determined location to a delivery device.

### FIELD OF THE INVENTION

The present invention relates to inventory management. In particular, the present invention relates to systems and methods for product selection, retrieval and delivery.

### BACKGROUND OF THE INVENTION

Inventory management systems have been used for years by manufacturers, retailers, wholesalers, and other businesses. Some of these systems allow business to link customer purchases to restocking orders. Other systems allow customers to select a product and have that product delivered to a pick-up area without the need for the customer to actually handle the product. For example, retailer, Service Merchandise (tm), required customers to select a tag corresponding to a product and present that tag to a customer service representative at the checkout counter. Once the customer had paid for the product, an order indicating the customer and the purchased product was relayed to a product warehouse. Warehouse personnel then retrieved the purchased product and delivered it to the waiting customer. Of course, the customer did not get the actual product that he saw on the showroom floor. Instead, the customer received a product of the same type as the product on the showroom floor.

The above-described inventory management system is generally adequate for fungible items such as TVs and stereos because the customer does not care which particular product is delivered. Rather, the customer only cares that the delivered product is of a certain brand and model. In other words, the customer only wants the delivered TV to match the TV on the showroom floor.

Although the Service Merchandise-type inventory management system is adequate for fungible items, it is completely unsatisfactory for non-fungible items. For example, present inventory management systems are practically useless for nurseries because each plant at a nursery is unique, and because customers want to purchase a specific plant rather than a particular type and size of plant. Accordingly, a system and method are needed to manage inventories that include non-fungible products. In particular, a system and method are needed to aid in the selection, location, retrieval and delivery of non-fungible products.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

In one embodiment, the present invention includes a system and method for selecting, locating, retrieving and delivering non-fungible products. For example, a customer can initially select a particular product for purchase. The customer can make this selection in a variety of ways. For example, the customer can scan a barcode attached to the product. Alternatively, the customer can electronically read information from the product through means such as RF. In yet other embodiments, the customer could remove a tag from the product and take the tag to a customer service representative for scanning.

After the customer selects the product for purchase, a unique identifier for that product can then be provided to an order processing system (“OPS”). The OPS can then compare the unique identifier to a product database and determine a location for the product. Alternatively, the unique identifier could include the product's location information. Whether the location information is contained in the unique identifier or retrieved from a product database, the OPS can relay the unique identifier, the product location and other useful information to a delivery system. The delivery system can then schedule the retrieval and/or pickup of the selected product. For example, the delivery system could relay the unique identifier and the location to delivery personnel who could then retrieve the exact product that the customer selected and deliver that product to the customer.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a flowchart showing one method in accordance with the present invention;

FIG. 2 is a block diagram showing a system in accordance with the present invention;

FIG. 3 illustrates an identification tag that can be attached to a non-fungible product;

FIG. 4 is a flowchart showing another method in accordance with the present invention;

FIG. 5 illustrates a wireless device for use in the method of FIG. 4; and

FIG. 6 is a flowchart of a method for determining the placement of non-fungible products within an inventory layout.

### DETAILED DESCRIPTION

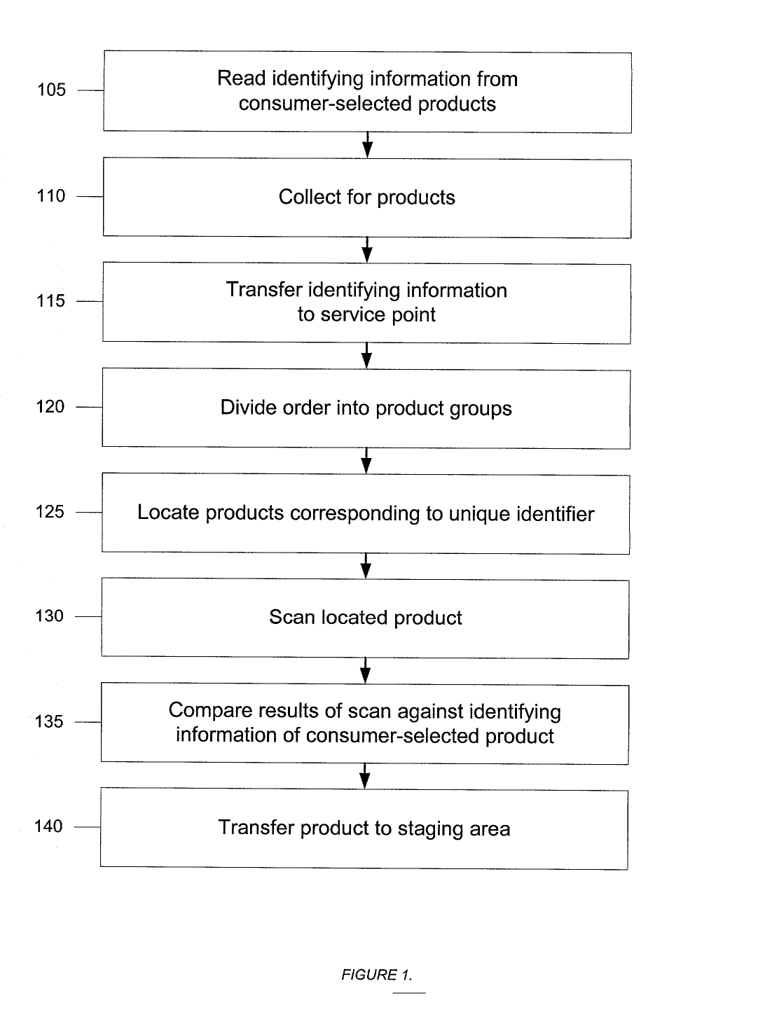

Referring now to the drawings, where like or similar elements are designated with identical reference numerals throughout the several views, and referring in particular to FIG. 1, it is a flowchart showing one method in accordance with the present invention. In this embodiment, a customer initially selects a unique, e.g., non-fungible, product for purchase. The customer can select the product, for example, by electronically reading the product's identifying information or by manually collecting that information through, for example, removable tags (step 105).

Once the product's identifying information is collected, the product information is next transferred from the customer to a point of sale (“POS”) device or an order management system. When the product information is transferred to the POS, a total purchase price can be calculated and collected (step 110). In some embodiments, the POS device, or a connected device, may recommend related products. For example, if a purchased plant has unique fertilizer needs, an appropriate recommendation can be generated.

After the selected products have been purchased, the relevant product information can be transferred to a delivery management system, which could be a centralized or distributed location (step 115). For example, the product information could be transferred to a centralized delivery management system that can queue and schedule product retrievals and deliveries. For example, the delivery management system could determine that a particular order should be retrieved next and that the order should be delivered to a particular staging area. In alternate embodiments, the order retrieval could be divided into smaller jobs (step 120). For example, in a nursery, a first delivery agent could be assigned to the tree section and a second delivery agent assigned to the flower section. When an order is received that includes both trees and flowers, the delivery management system could divide the order and send the tree portion to the first delivery agent and the flower portion to the second delivery agent. The two agents could then retrieve their individual portions of the order and deliver them to the customer.

In one embodiment, after locating the product selected by the customer, the delivery agent can electronically read the identifying information from the product (steps 125 and 130). For example, the delivery agent could scan the product's tag. The results of the scan could then be relayed to the order processing system (OPS) for matching against the customer's order (step 135). If the scanned product does not match the customer's order, the OPS can notify the delivery agent. Otherwise, the product can be delivered to the customer (step 140).

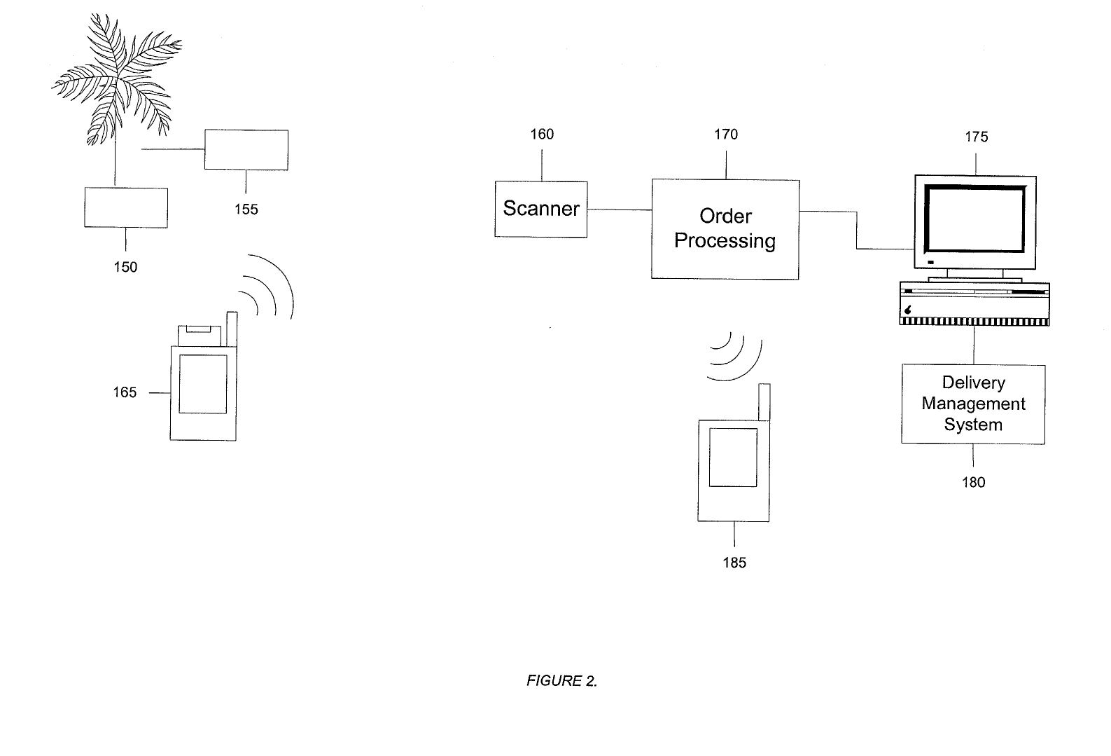

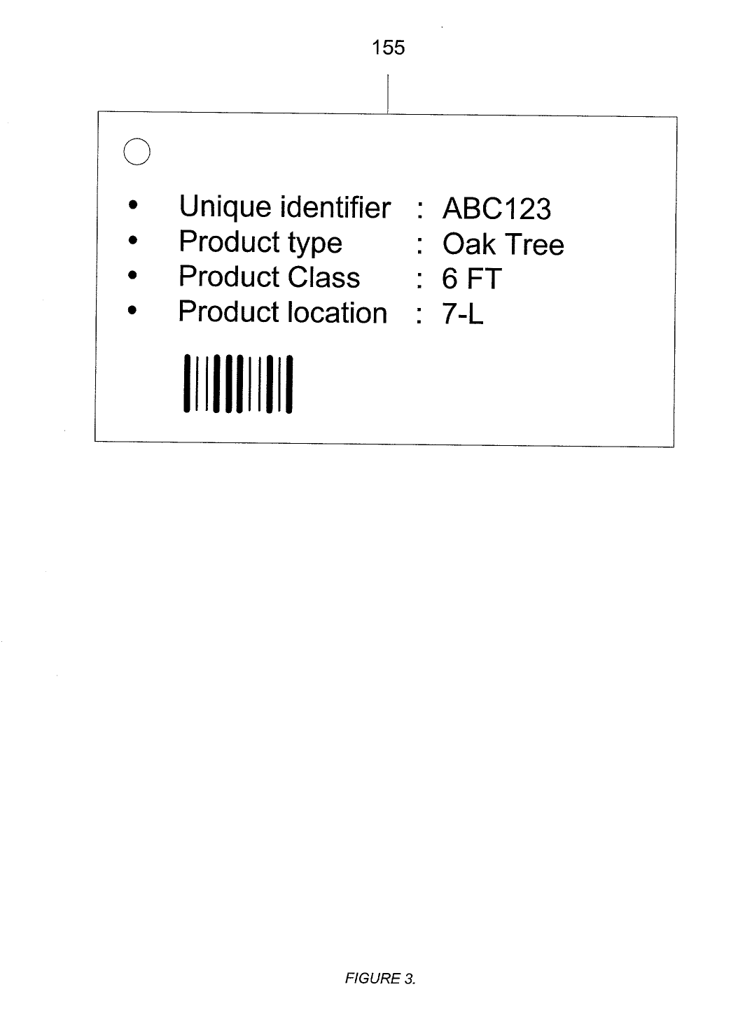

FIG. 2 is a block diagram of a system 145 in accordance with one embodiment of the present invention. In this embodiment, a customer identifies a product 150, such as a particular tree, and either scans a tag 155 (shown in detail in FIG. 3) attached to the product or removes a tag from the product for future scanning at, for example, a customer service scanning station 160. The customer can scan the label with a non-wireless scanner, wireless-scanner or a scanning-enabled PDA. The scanning device 165 can either locally store the information until the order is finalized or wirelessly relay the product information to an OPS prior to the entire order being finalized 170. For example, the scanning device 165 could store the information and download it directly to a POS device 175 or wirelessly relay the product information to a POS device 175 or an OPS 170.

When product information is relayed to the POS device or the OPS, that device can then determine pricing information, discount information, sale information, upsell information, etc. Portions of this information can then be relayed back to the customer's scanning device 165 and subsequently displayed for the customer. In other embodiments, the customer's scanning device 165 could be directly loaded with the relevant information, thereby eliminating the need for the wireless connection.

When the scanning device 165 is wirelessly connected to the OPS 170, the customer can finalize an order or portion of an order by activating the appropriate feature on the scanning device 165. The scanning device 165 can then relay the order information to the POS device and/or the OPS (which could be integrated into a single unit) 110. The appropriate device can then adjust the customer's account and relay the order information to the delivery management system 180. A unique identifier for the selected product and the location of that product, both of which are generally included in the order information, can be forwarded to delivery personnel 185 who can locate and retrieve the exact product that the customer selected and then deliver it to the customer. Thus, in the case of a nursery, a customer is never required to actually handle the usually heavy, cumbersome and dirty plants.

Because many customers may be adverse to technology, an alternate product selection means is needed. Accordingly, in one embodiment, customers merely remove, rather than scan, the tag 155 from the exact product in which they are interested. Customers can then take the tags to a POS device 175 and proceed through a standard check out. A sales agent, for example, can scan the tags 155 for the customer and possibly collect payment. Information regarding the purchased products can then be relayed to the OPS 170 and to the delivery personnel 185.

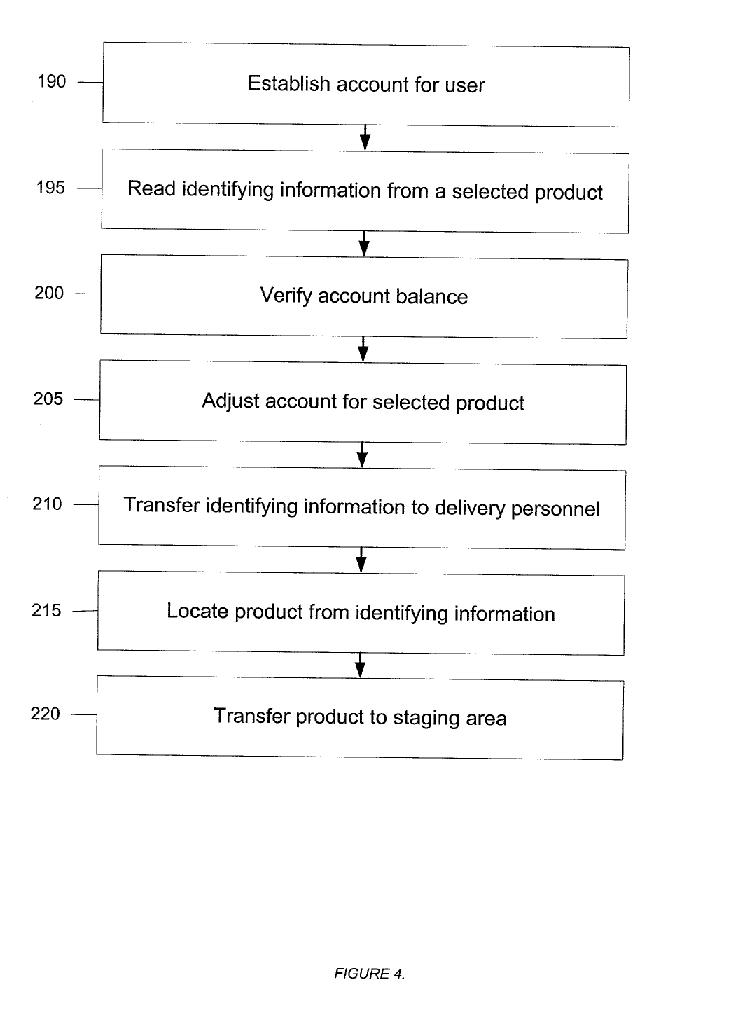

Referring now to FIG. 4, it is a flowchart of another method in accordance with the present invention. In this embodiment, a customer, or the customer' agent, initially establishes an account (step 190). A typical account could indicate a credit line, a delivery address, and delivery instructions. For example, a customer's account could indicate a $1,000 line of credit, the customer's home for a delivery address, and a delivery schedule to be determined by a landscaper. Such an account could be particularly beneficial to general contractors, landscapers because they could establish an account for each project and let the customer select the plants to be used in the project. After the customer selects the plants, the contractor would then have the ability to control the delivery date and delivery location.

Still referring to FIG. 4, after the customer's account has been established, the customer can select the particular products of interest and either scan or collect their tags. When a tag is scanned, the price of the product can be compared against the balance of the customer's account and, assuming the account has enough credit, the sale can be finalized and the customer's account adjusted (steps 195, 200 and 205). The product's identifying information can then be transferred to the delivery management system and to the delivery personnel who can retrieve and deliver the product (steps 210, 215 and 220).

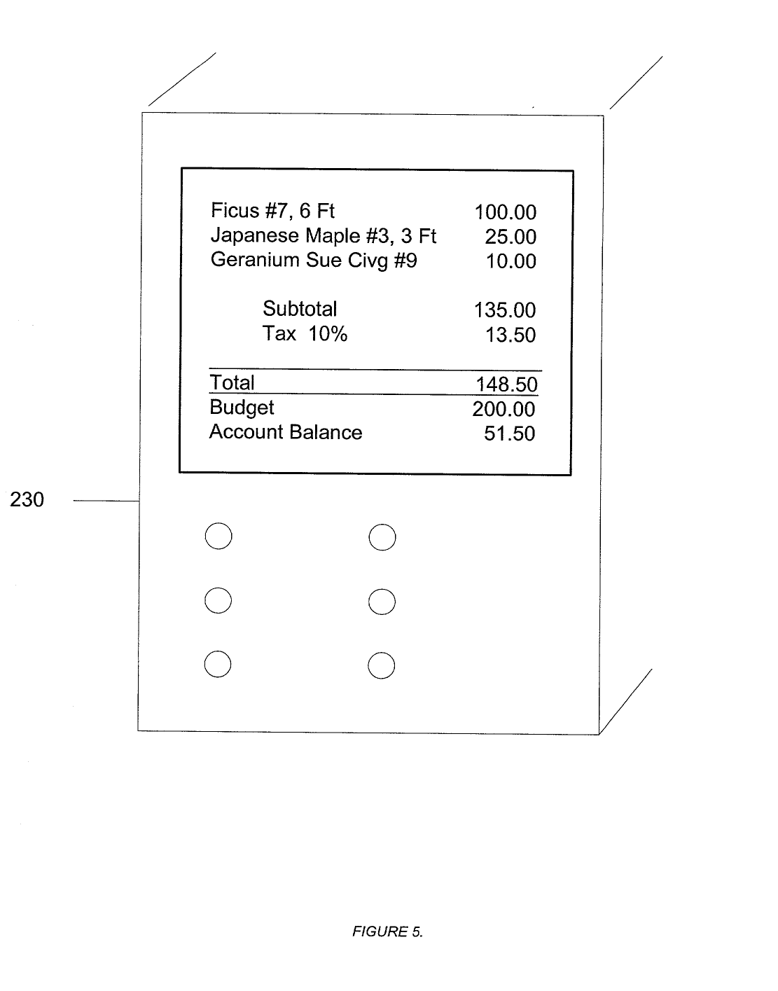

Referring now to FIG. 5, it illustrates one embodiment of a scanner 230 for use in certain embodiments of the present invention. This scanner 230 includes a wireless computer device with an integrated barcode reader. As the customer selects products, related product information appears on the display screen. The displayed information could come directly from the scanned tag, or the displayed information could be retrieved from a remote database. As can be appreciated by those of skill in the art, other scanning devices, with or without a display screen, can also be used.

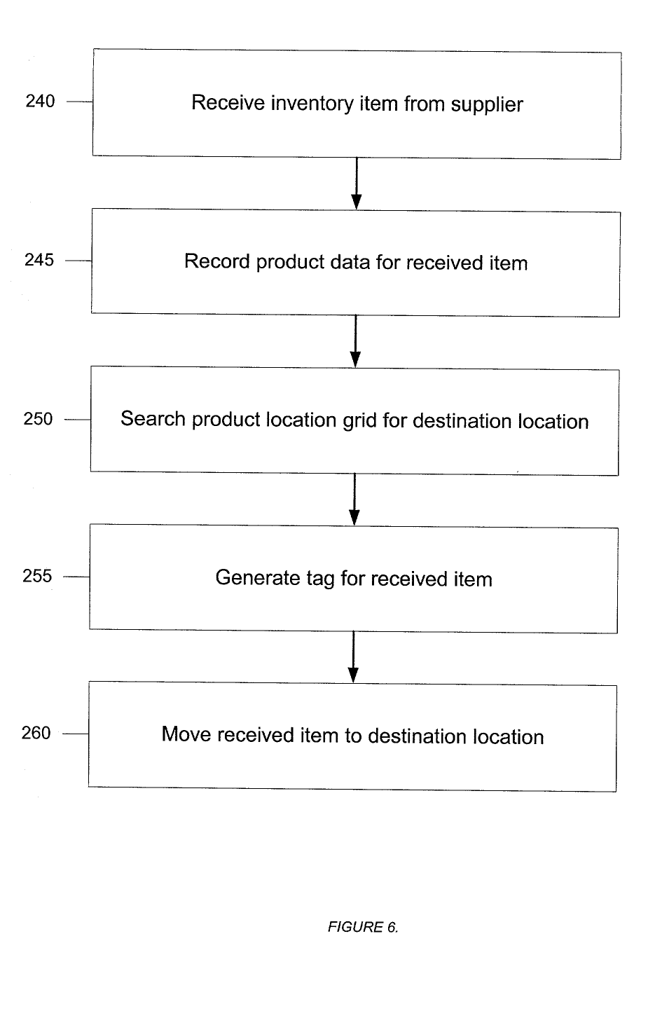

Referring now to FIG. 6, it is a flowchart of a method for determining the placement of non-fungible products within an inventory layout. In this embodiment, a business receives a non-fungible inventory item from a supplier (step 240). For example, the business could receive a new six-foot oak tree from a tree farm. Data regarding the product could then be entered into an inventory management system that could record that the product was received and recommend where within the business to physically locate the product (step 245). For example, the inventory management system could determine that all oak trees are located in zone A of the business and that six-foot oak trees are located in subzone 3. Thus, the inventory management system could recommend that the new oak tree should be located somewhere in zone A, subzone B.

In particular, the inventory management system could search for empty spaces or bins within that zone and subzone (step 250). For example, the inventory management system could keep a record of each product sold and the physical location, e.g., zone, subzone, and/or space) within the business from which that product came. When a product is sold or otherwise disposed of, the space from which it came can be marked as empty. Thus, the inventory management system could search for “empty” spaces corresponding to the characteristics of the received inventory item.

Once an empty space in which to locate the inventory item has been identified, a tag identifying the inventory item and the recommended location can be printed and secured to the inventory item (step 255). The inventory item then can be physically moved to the identified space, and the inventory management system can mark the space as “occupied” (step 260).

In conclusion, the present invention provides, among other things, a system and method for managing, retrieving and/or delivering non-fungible products. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing inventory:
receiving a product identifier for a selected product, wherein the product includes a unique identifier;
transferring the product identifier to a service point;
retrieving a product class identifier using the unique identifier;
retrieving a positional indicator associated with the unique identifier;
retrieving a cost for the selected product using the product class identifier or the product identifier;
providing the product identifier and the positional indicator to an order management system; and
scheduling retrieval of the selected product from the position associated with the positional indicator.

2. The method of claim 1, further comprising:
recording in a list of positions that the position associated with the positional indicator is empty.

3. The method of claim 1, wherein transferring comprises:
wirelessly transferring the product identifier.

4. The method of claim 1, wherein the product class identifier indicates a plant type and a plant size.

5. The system for inventory management, the system comprising:
scanner for reading a unique identifier associated with a non-fungible product;
an order processing center in communication with the scanner, the order processing center for determining the location of the non-fungible product; and
a delivery notification center connected to the order processing center, the delivery notification center configured to indicate the location of the non-fungible item and a delivery location.

6. The system of claim 5, wherein the scanner is a wireless device.

7. The system of claim 5, wherein the order processing center is further configured to schedule retrieval of the non-fungible product.

8. A method for managing an inventory, the method comprising:
establishing an account for a customer, the account having an account balance;
receiving product information, the product information corresponding to a non-fungible product selected by the customer;
determining a cost for the selected non-fungible product;
verifying that the account balance is equal to or greater than the cost for the selected non-fungible product;
adjusting the account balance by the cost associated with the selected non-fungible product;
determining a location for the selected non-fungible product; and
transferring the product information and the determined location to a delivery notification device.

9. The method of claim 8, wherein the account indicates a customer identifier, a delivery address, a billing address and a contractor identifier.

10. The method of claim 8, further comprising:
retrieving a product location from a database, wherein the product location is associated with the product information.

11. A system for managing an inventory, the system comprising:
means for establishing an account for a customer, the account having an account balance;
means for receiving a unique product identifier corresponding to a non-fungible product selected by the customer;
means for verifying that the account balance is equal to or greater than a cost associated with the selected product;
means for adjusting the account balance by the cost associated with the selected product;
means for determining a location for the selected product; and
means for transferring the unique product identifier and the determined location to a delivery notification device.

12. The system of claim 11, wherein the account indicates a customer identifier, a delivery address, a billing address and a contractor identifier.

13. A method for managing an inventory, the method comprising:
receiving an inventory item to be placed in an inventory stock;
electronically recording product data for the received inventory item;
searching inventory location data for a destination location at which to locate the received inventory item, wherein the inventory location data indicates a plurality of spaces for locating the inventory stock and also indicates whether a particular space within the plurality of spaces is available.
